(19) United States
(12) Patent Application Publication
(10) Pub. No.: US 2003/0225176 A1
(43) Pub. Date: Dec. 4, 2003

(54) Blowing agent blends

(75) Inventors: Jinhuang Wu, Norristown, PA (US); Douglas R. Dillon, Norristown, PA (US)

Correspondence Address: ATOFINA CHEMICALS INC., PATENT DEPARTMENT - 26TH FLOOR, 2000 MARKET STREET, PHILADELPHIA, PA, 19103-3222, US

(73) Assignee: ATOFINA Chemicals, Inc.

(21) Appl. No.: 10/162,146

(22) Filed: Jun. 3, 2002

(51) Int. Cl. C08J 9/00

(52) U.S. Cl. 521/155; 521/98; 521/131; 516/10; 516/12

(57) ABSTRACT

Foam blowing agent blends of trans-1,2-dichloroethylene and one or more pentanes are provided, as are polyol premixes and foam compositions containing such blends. The resulting foams exhibit dramatic improvement in fire resistance.

### BACKGROUND OF THE INVENTION

This invention relates to foam blowing agent blends of trans-1,2-dichloro-ethylene (“Trans 12”) with one or more pentanes, and to polyol premixes and foam compositions containing such blends, more specifically to blends of Trans 12 with one or more of n-pentane (“n-C5”), i-pentane (“i-C5”) and cyclopentane (“c-C5”). The foam blowing agent blends are particularly useful for making closed cell polymer (insulation) foams having improved fire resistance, such as polystyrene, phenolic and polyurethane foams.

Chlorofluorocarbons (“CFCs”) had been used as blowing agents for rigid, closed cell insulation foams for many years because they offer outstanding fire resistance in addition to good thermal insulation. However, CFCs have been phased out because they are said to be detrimental to the ozone layer. Zero ozone depletion alternatives such as pentanes have been identified, but pentanes are highly flammable and their resulting foams suffer undesirable fire performance properties. It is increasingly difficult for pentane blown foams to meet stringent fire performance requirements, so that yet another alternative with better fire resistance performance is desirable.

### BRIEF SUMMARY OF THE INVENTION

Foam blowing agent compositions are provided, which compositions comprise Trans 12 and at least one pentane selected from the group consisting of n-C5, i-C5 and c-C5 (preferably c-C5), as well as foam premix and polyurethane foam compositions comprising a polyol and the blowing agent composition.

### DETAILED DESCRIPTION

It has now been found that the foregoing blends of pentanes with Trans 12 dramatically improves fire resistance of pentane blown foams, as well as improving the initial k-factor (thermal conductivity) of such foams. As noted above, these blends are particularly useful for making closed cell polymer (insulation) foams having improved fire resistance, such as polystyrene, phenolic and polyurethane foams.

Trans 12 generally makes up greater than 1 mole % of the blends, preferably about 5 to 25 mole %. A practical upper limit on the amount of Trans 12 is about 40 to 45 mole %.

In the premix compositions the blowing agent blend is typically present in a concentration range of about 2-60 weight % (preferably 5-40 weight %), based on the weight of the polyol.

In polyurethane foam compositions, the effective concentrations of the blends are typically about 0.1-25 weight % (preferably 0.5-15 weight %), based on the weight of the total polyurethane foam formulation.

The blowing agent can be distributed between the “A” and “B” sides of the foam composition. All or a portion of it can also be added at the time of injection.

The other components of the premix and foam formulations may be those which are conventionally used, which components and their proportions are well known to those skilled in the art. For example, fire retardants, surfactants and polyol are typical components of the B-side, while the A-side is primarily comprised of polyisocyanate. Water is frequently used as a coblowing agent. The A and B sides are typically mixed together, followed by injection of the catalyst, after which the mixture is poured into a mold or box.

The practice of the invention is illustrated in more detail in the following non-limiting examples. The formulations used (all having an Iso Index of 300) each contained 170.51 parts M-489, a polymeric methane diphenyl diisocyanate available from Bayer Corporation; 100 parts PS2352, a polyester polyol having a hydroxyl number of 230-250 available from the Stepan Company; 0.16 part PC-5 and 0.29 part PC-46, which are, respectively, pentamethyldiethylenetriamine and potassium acetate in ethylene glycol, catalysts available from Air Products; 2.57 parts K-1 5, potassium octoate in dipropylene glycol, a catalyst available from Air Products; 2 parts B-8462, a polysiloxane-polyether copolymer surfactant available from Goldschmidt Chemical Corporation; 10 parts AB-80, a tris(1-chloro-2-propyl)phosphate fire retardant available from Albright & Wilson Americas, Inc.; and about 22-24 parts blowing agent, the exact amounts of which are more particularly set forth below in Tables I and II below; all parts are by weight.

### Table I—Parts of Blowing Agent in Comparative Example: 21.7 parts c-C5

TABLE II
Parts & Mole % (of Trans 12) of Blowing Agent in Invention Examples

| c-C5 | 20.62 | 19.53 | 16.28 |
|---|---|---|---|
| Trans 12 parts | 1.50 | 3.01 | 7.52 |
| Trans 12 mole % | 5 | 10 | 25 |

The A-side (M489) and B-side (a mixture of the polyol, surfactant, fire retardant and blowing agents) were each cooled to 1020 C., then mixed, after which the catalyst mixture was injected. After further mixing for about 18 seconds, the mixture was poured into a box. A Mobil 45 fire resistance performance test was then performed on samples of the resulting foams. In this test samples are weighed before and after exposure to a burner and the weight loss percentage is calculated. The less the weight loss, the better the fire performance. The results are shown in Table III:

TABLE III
Mobil 45 Fire Resistance Weight Loss % Results:

| | |
|---|---|
| c-C5 alone: | 10.3% |
| c-C5 with 5 mole % Trans 12 | 6.1% |
| c-C5 with 10 mole % Trans 12: | 8.6% |
| c-C5 with 25 mole % Trans 12: | 3.0% |

The foam made with c-C5 alone had an initial k-factor of 0.157 Btu.in./ft².h.° F. at 24° C., while the foams made with the 3 levels of Trans 12 had k-factors of 0.153, 0.153 and 0.149, respectively.

We claim:

1. A foam blowing agent composition comprising trans-1,2-dichloroethylene and at least one pentane selected from the group consisting of n-pentane, i-pentane and cyclopentane.

2. A foam blowing agent composition comprising trans-1,2-dichloroethylene and cyclopentane.

3. A foam premix composition comprising a polyol and the foam blowing agent composition of claim 1.

4. A foam premix composition comprising a polyol and the foam blowing agent composition of claim 2.

5. A polyurethane foam composition comprising an isocyanate, a polyol and the foam blowing agent composition of claim 1.

6. A polyurethane foam composition comprising an isocyanate, a polyol and the foam blowing agent composition of claim 2.
